(19) United States
(12) Patent Application Publication
(10) Pub. No.: US 2020/0215861 A1
(43) Pub. Date: Jul. 9, 2020

(54) METHOD OF MANUFACTURING A ONE-PIECE TRAILER HITCH

(71) Applicant: Benjamin Steven Johnson, Dorr, MI (US)

(72) Inventor: Benjamin Steven Johnson, Dorr, MI (US)

(21) Appl. No.: 16/737,576

(22) Filed: Jan. 8, 2020

Related U.S. Application Data
(60) Provisional application No. 62/790,051, filed on Jan. 9, 2019.

(51) Int. Cl. B60D 1/06

(52) U.S. Cl. CPC B60D 1/06

(57) ABSTRACT

A method of manufacturing a unitary hitch formed from a single hitch blank through the folding or bending of the hitch blank along various transition lines. The hitch blank may provide a symmetrical body-arm-hand-head configuration facilitating the folding along at least four transition lines so as to form the unitary hitch with spaced apart hitch ball holes and spaced apart pin holes.

### CROSS-REFERENCE TO RELATED APPLICATION

This application claims the benefit of priority of U.S. provisional application No. 62/790,051, filed 9 Jan. 2019, the contents of which are herein incorporated by reference.

### BACKGROUND OF THE INVENTION

The present invention relates to a trailer hitches and, more particularly, to a method of manufacturing a one-piece trailer hitch.

Currently, trailer hitches are made with multiple pieces that are welded together; thus, each piece needs to be independently fabricated and joined. The process of fabricating and joining these separate pieces introduces costs in terms of manhours and equipment, as well as increases the likelihood of an error.

As can be seen, there is a need for a method of manufacturing a trailer hitch from a unitary sheet of material without welding or other joining methodologies. The present invention incorporates only a single step in the process to make the (one-piece stamped) trailer hitch. In other words, the stamped one-piece trailer hitch does not need welding or multiple pieces to be manufacturer, which is far more cost effective than current methods.

### SUMMARY OF THE INVENTION

In one aspect of the present invention, hitch blank for forming a unitary hitch without welding includes the following: a planar sheet of material having a body-arm-hand-neck-head configuration symmetrical along a longitudinal axis thereof; the body-arm-hand-neck-head configuration providing: a body portion providing: a top tube plate separated by a first side tube plate and a second side tube plate, by two opposing first transition lines; and the body portion extending from a proximal end and a distal end; a head portion providing: an angled plate extending from the distal end and separated therefrom by a fourth transition line; and a hitch ball plate colinearly extending from the angled plate and separated therefrom by a third transition line; two arm portions, each arm portion extending away from the distal end and the head portion; each arm portion defined in part by an exterior edge facing the head portion; and each arm portion generally bisected by a second transition line; and two hand portions, each hand portion extending in a colinear relationship with the hitch ball plate away from a distal end of each arm portion; each hand portion defined in part by an exterior edge facing away from each exterior edge; and each hand portion generally bisected by the second transition line.

In another aspect of the present invention, the hitch blank for forming a unitary hitch without welding further includes: a first pin hole in the first side tube plate; and a second pin hole in the second side tube plate, wherein the first and second pin holes are oriented in a mirror image relative to each other; an upper hitch ball hole in the hitch ball plate; a semi-circular lower hitch ball hole in each hand portion so as to further define each exterior edge; and two spaced apart fold notches defining a neck portion of the body-arm-hand-neck-head configuration, wherein the neck portion interconnects the body and head portions.

In yet another aspect of the present invention, a method of manufacturing a unitary hitch without welding includes the following: providing the hitch blank mentioned above; folding along the two first transition lines until the top tube plate is in a orthogonal orientation relative to the first side tube plate and the second side tube plate; folding along the two second transition lines so that the two exterior edges abut; folding along the third transition line so that the angled plate and the hitch ball plate are orientated at an obtuse angle relative to each other; and folding along the fourth transition lines so that a periphery of the angle plate abuts a portion of the two interior edges and a periphery of the hitch ball plate abuts another portion of the two interior edges.

In yet another aspect of the present invention, a method of manufacturing a unitary hitch without welding includes the following: a body portion providing: a centrally disposed top tube plate; a first side tube plate and a second side tube plate extending from the top tube plate along two opposing first transition lines, respectively; the first bottom tube plate and the second bottom tube plate extending from the first side tube plate and a second side tube plate, respectively, each along an associated second transition line; and the body portion extending from a proximal end and a distal end, wherein there is an opening between the first bottom tube plate and a second bottom tube plate after folding along the second transition lines.

These and other features, aspects and advantages of the present invention will become better understood with reference to the following drawings, description and claims.

### BRIEF DESCRIPTION OF THE DRAWINGS

FIG. 1 is a top front perspective view of an exemplary embodiment of the present invention;

FIG. 2 is a bottom rear perspective view of an exemplary embodiment of the present invention;

FIG. 3 is a section view of an exemplary embodiment of the present invention, taken along line 3-3 of FIG. 1;

FIG. 4 is a section view of an exemplary embodiment of the present invention, taken along line 4-4 of FIG. 3;

FIG. 5 is a section view of an exemplary embodiment of the present invention, taken along line 5-5 of FIG. 3;

FIG. 6 is a perspective view of an exemplary embodiment of the present invention, shown in a flat condition;

FIG. 7 is a perspective view of an exemplary embodiment of the present invention, illustrating a first fold along a first transition line;

FIG. 8 is a perspective view of an exemplary embodiment of the present invention, illustrating a second fold along a second transition line;

FIG. 9 is a perspective view of an exemplary embodiment of the present invention, illustrating a third fold along a third transition line;

FIG. 10 is a perspective view of an exemplary embodiment of the present invention, illustrating a fourth fold along a fourth transition line; and

FIG. 11 is a perspective view of an exemplary embodiment of the present invention, shown with an exemplary hitch ball 36 and hitch pin 38.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of manufacturing a unitary hitch formed from a single hitch blank through the folding or bending of the hitch blank along various transition lines. The hitch blank may provide a symmetrical body-arm-hand-head configuration facilitating the folding along at least four transition lines so as to form the unitary hitch with spaced apart hitch ball holes and spaced apart pin holes.

It should be understood by those skilled in the art that the use of directional terms such as upper, lower, upward, downwardly, top, left, right and the like are used in relation to the illustrative embodiments as they are depicted in the figures, the upward direction (or upper) being toward the top of the corresponding figures and the downward direction being toward the bottom of the corresponding figures.

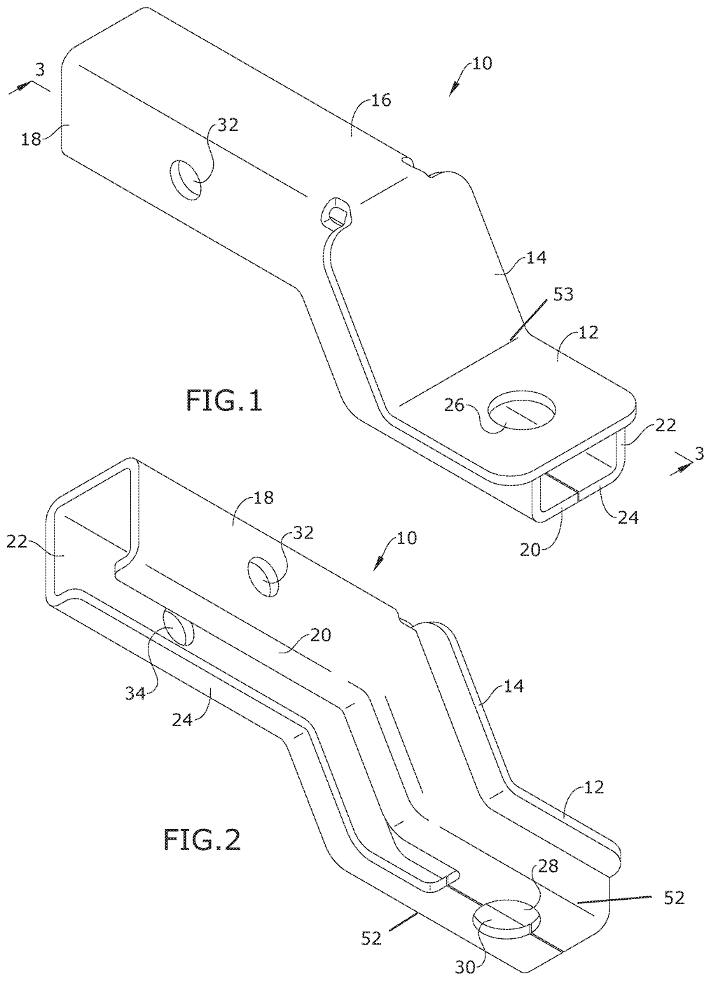

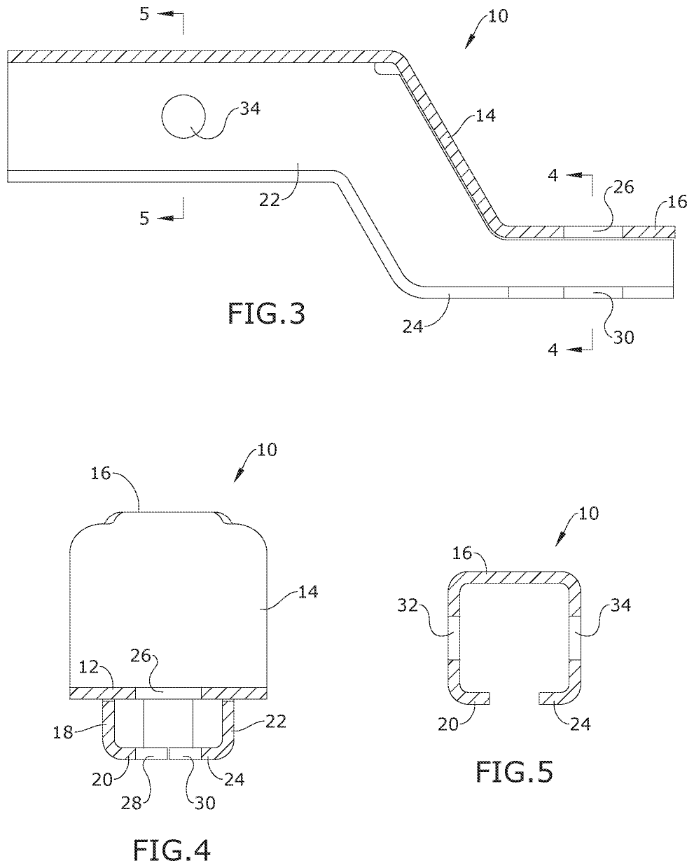

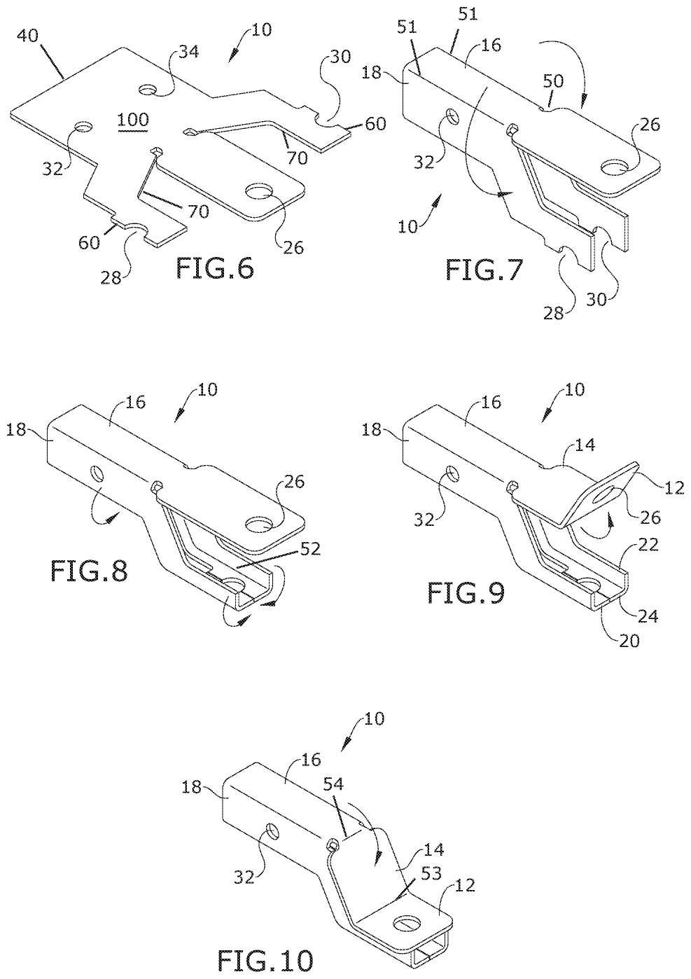

Referring to FIGS. 1 through 11, the present invention may include a unitary hitch 10 and a method of manufacturing the same. The unitary hitch 10 may be laser cut or stamped (through a die and stamping press, for instance) from a sheet of material to form the hitch blank 100 illustrated in FIG. 6. The hitch blank 100 may also be fed through a die press to form the end-product—the unitary hitch 10. The cutting process may be followed by a brake press forming process and/or use of some special tooling. The sheet of material may be sheet metal or other metallicized material, various plasticized materials or synthetic materials that are strong enough to withstand the repeated bending of the manufacturing process as well as the forces required of the unitary trail hitch 10 without failure.

The designed shape of the hitch blank 100 may include a top tube plate 16 having a first side tube plate 18 and a second side tube plate 22 on opposing longitudinal sides thereof, separated by first transition lines 51. The tube plates 16, 18, and 22 extend from a proximal end 40 to an opposing distal end. The first and second side tube plates 18 and 22 provide a respective first and second pin hole 32 and 34 that align and are mirror images along a centrally disposed longitudinal axis running the long way along the hitch blank 100 from a midpoint along the proximal end. The hitch blank 100 is symmetrical about said longitudinal axis.

From a fourth transition line 54 along the distal end an angled plate section 14 extends from the top tube plate 16. The angled plate section 14 transitions into a hitch ball section 12 at a third transition line 53, running parallel to the fourth transition line 54.

A first bottom tube plate 20 and a second bottom tube plate 24 on opposing sides may extend from the proximal end 40 along the side of the first side tube plate 18 and a second side tube plate 22, respectively, opposite the top tube plate 16 until the distal end, whereat the bottom tube plates 20 and 24 turns and extends outwardly away from the angled plate section 14 at approximately a forty-five-degree angle until approximately a transition line generally colinear with the third transition line 53 whereat each bottom tube plate 20 and 24 turns back to run parallel with the hitch ball plate 12, thereby replicating an arm and hand configuration (the exterior edge 60 of bottom tube plates 20 and 24 defining the outer edge 60 of the ‘arms’ and the ‘hands’). It is understood that the first and second side tube plates 18 and 22 also form an innermost portion of the ‘arms’ and hands along an interior edge 70 thereof.

Additionally, the angled plate 14 and hitch ball sections 12 replicate the ‘head’ in such a configuration, amounting to what could be called a body-arm-hand-head configuration, wherein the tube plates 16, 18 and 22 define the ‘body’ portion of such configuration.

Separating the angled plate section 14 and the first and second side tube plates 18 and 22 along the distal end may be two, spaced apart fold notches 50, as shown in the illustrations. The fold notches 50 can be viewed has defining a ‘neck’ portion of a body-arm-hand-neck-head configuration.

Each bottom tube plate 20 and 24 portion of the ‘hand’ may provide a semi-circular hole 28 or 30, so that if both semi-circular holes 28 and 30 were to abut they would form one lower hitch ball hole. The hitch ball section 12 may provide an upper hitch ball hole 26 that is bisected by the above-mentioned longitudinal axis.

Referring to FIG. 7 through 10, a method of manufacturing the unitary hitch 10 includes the following. The hitch blank 100 disclosed above may be provided.

Referring to FIG. 7, two first folds may be made along each first transition line 51 so that the top tube plate 16 is in an orthogonal relationship relative to the first and second side tube plates 18 and 22.

Referring to FIG. 8, two second folds may be along each second transition line 52 so that the exterior edges 60 of the first and second side tube plates 18 and 22 ‘hands’ abut, wherein the semi-circular holes 28 and 30 abut, forming said lower hitch ball hole. The second transition lines 52 continue to the proximal end 40 so that along the ‘body’ portion the exterior edges 60 of the bottom tube plates 20 and 24 face each other but are spaced apart. The opening between the exterior edges 60 of the bottom tube plates 20 and 24 enables an ‘open design’ to prevent the entrapment of water.

Referring to FIG. 9, then a third fold may be made along the third transition line 53 so that the angled plate section 14 and the hitch ball section 12 are at an obtuse angle relative to each other.

Referring to FIG. 10, a fourth fold may be made at the fourth transition line 54 so that the angled plate section 14 angles downward relative to the top tube plate 16, and so that the angled plate section 14 engages the interior edges 70 of the arms, while the hitch ball section 12 similarly engaged the interior edges 70 of the ‘hand’.

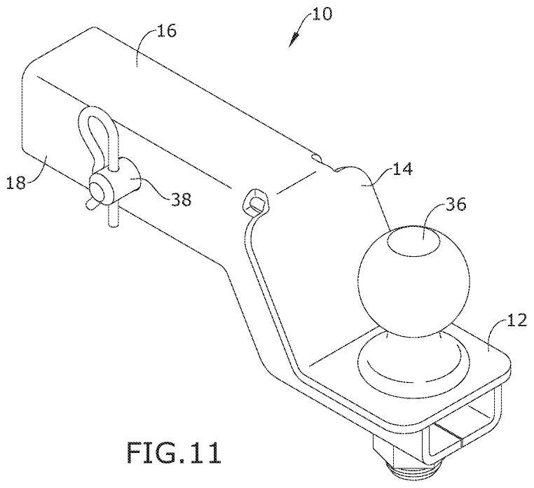

Referring to FIG. 11, then the manufacturer may provide the hitch ball 36 with a post that operatively associates both the lower hitch ball hole and the upper hitch ball hole 26. The manufacturer may operatively engage a hitch pin 38 through the aligned first and second pin hole 32 and 34.

The designed shape contributes to the strength and function of the unitary hitch 10. Design and manufactured features can be added to compliment functional needs and benefits. Additionally, a similar design and process could be consolidated into the manufacturing of and automobile bumper or frame. In certain embodiments, welds could be added for increasing the structural strength and rigidity to the unitary trail hitch 10.

It should be understood, of course, that the foregoing relates to exemplary embodiments of the invention and that modifications may be made without departing from the spirit and scope of the invention as set forth in the following claims.

What is claimed is:

1. A hitch blank for forming a unitary hitch without welding, comprising:
a planar sheet of material having a body-arm-hand-neck-head configuration symmetrical along a longitudinal axis thereof;
the body-arm-hand-neck-head configuration comprising:
a body portion comprising:
a top tube plate separated by a first side tube plate and a second side tube plate, by two opposing first transition lines; and
the body portion extending from a proximal end and a distal end;
a head portion comprising:
an angled plate extending from the distal end and separated therefrom by a fourth transition line; and
a hitch ball plate colinearly extending from the angled plate and separated therefrom by a third transition line;
two arm portions, each arm portion extending away from the distal end and the head portion;
each arm portion defined in part by an exterior edge facing the head portion; and
each arm portion generally bisected by a second transition line; and
two hand portions, each hand portion extending in a colinear relationship with the hitch ball plate away from a distal end of each arm portion;
each hand portion defined in part by an exterior edge facing away from each exterior edge; and
each hand portion generally bisected by the second transition line.

2. The hitch blank for forming a unitary hitch without welding of claim 1, further comprising:
a first pin hole in the first side tube plate; and
a second pin hole in the second side tube plate, wherein the first and second pin holes are oriented in a mirror image relative to each other.

3. The hitch blank for forming a unitary hitch without welding of claim 1, further comprising:
an upper hitch ball hole in the hitch ball plate.

4. The hitch blank for forming a unitary hitch without welding of claim 1, further comprising:
a semi-circular lower hitch ball hole in each hand portion so as to further define each exterior edge.

5. A hitch blank for forming a unitary hitch without welding, comprising:
a planar sheet of material having a body-arm-hand-neck-head configuration symmetrical along a longitudinal axis thereof;
the body-arm-hand-neck-head configuration comprising:
a body portion comprising:
a centrally disposed top tube plate;
a first side tube plate and a second side tube plate extending from the top tube plate along two opposing first transition lines, respectively;
the first bottom tube plate and the second bottom tube plate extending from the first side tube plate and a second side tube plate, respectively, each along an associated second transition line;
the body portion extending from a proximal end and a distal end;
a first pin hole in the first side tube plate; and
a second pin hole in the second side tube plate, wherein the first and second pin holes are oriented in a mirror image relative to each other;
a head portion comprising:
an angled plate extending from the distal end and separated therefrom by a fourth transition line;
a hitch ball plate colinearly extending from the angled plate and separated therefrom by a third transition line; and
and upper hitch ball hole in the hitch ball plate;
two arm portions, each arm portion extending away from the distal end and the head portion;
each arm portion defined in part by an exterior edge facing the head portion; and
each arm portion generally bisected by a second transition line, wherein each second transition line separates the first side and first bottom tube plates or the second side and second bottom tube plates; and
two hand portions, each hand portion extending in a colinear relationship with the hitch ball plate away from a distal end of each arm portion;
each hand portion defined in part by an exterior edge facing away from each exterior edge;
each hand portion generally bisected by the second transition line; and
a semi-circular lower hitch ball hole in each hand portion so as to further define each exterior edge.

6. The hitch blank for forming a unitary hitch without welding of claim 5, further comprising two spaced apart fold notches defining a neck portion of the body-arm-hand-neck-head configuration, wherein the neck portion interconnects the body and head portions.

7. A method of manufacturing a unitary hitch without welding, comprising:
providing the hitch blank of claim 5;
folding along the two first transition lines until the top tube plate is in a orthogonal orientation relative to the first side tube plate and the second side tube plate;
folding along the two second transition lines so that the two exterior edges abut;
folding along the third transition line so that the angled plate and the hitch ball plate are orientated at an obtuse angle relative to each other; and
folding along the fourth transition lines so that a periphery of the angle plate abuts a portion of the two interior edges and a periphery of the hitch ball plate abuts another portion of the two interior edges.

8. The method of claim 7, further comprising operatively engaging a hitch ball through the upper hitch ball hole and the two semi circular lower hitch ball holes; and operatively associating a hitch pin through the first and second pine holes.

9. The method of claim 7, wherein there is an opening between the first bottom tube plate and a second bottom tube plate after folding along the second transition lines.
